(19) United States
(12) Patent Application Publication
(10) Pub. No.: US 2009/0206119 A1
(43) Pub. Date: Aug. 20, 2009

(54) Striking Tool

(76) Inventor: Kouji Kubo, Tokyo (JP)

Correspondence Address: DRINKER BIDDLE & REATH (DC), 1500 K STREET, N.W., SUITE 1100, WASHINGTON, DC, 20005-1209, US

(21) Appl. No.: 11/921,740

(22) PCT Filed: Jun. 7, 2006
(86) PCT No.: PCT/JP2006/311435

§ 371 Date: Dec. 7, 2007

(30) Foreign Application Priority Data
Jun. 8, 2005 (JP) 2005-168523
Apr. 17, 2006 (JP) 2006-113793

(51) Int. Cl. B25C 7/00; B25C 1/04

(52) U.S. Cl. 227/8; 227/130

(57) ABSTRACT

In a contact mechanism operable to cause an operation of a trigger to be effective by relatively moving upward with respect to a nose portion 4, a lower contact member 11 is held between two springs 23, 24 provided respectively at upper and lower positions near the nose portion 4, and a lower end of the lower contact member 11 is biased by the upper spring 23 so as to protrude downward from a lower end of the nose portion. Further, there is provided a switching device 28 which can switch between a first position in which the lower contact member 11 is held at an upper position against the upper spring 23, a second position in which the contact member is held at a lower position against the lower spring 24, and a third position in which a movement of the contact member is not restricted.

### TECHNICAL FIELD

The present invention relates to a striking tool, such as a nailer or a screw driving machine, capable of switching between a type in which a stroke for pressing is not necessary (hereinafter, a non-stroking type) and a contact type. More specifically, the present invention relates to a contact mechanism of the striking tool.

### BACKGROUND ART

A striking tool strikes a fastener, such as a nail or a screw, into a wood or a concrete. There are a contact type striking tool which is activated only when a contact member (generally called as a contact arm or a contact nose), which has an ejection path for a fastener and is slidably provided along a nose portion, is pressed against a material to be fastened, and a non-stroking type striking tool which can be activated without pressing the contact member.

In the contact type striking tool, an activating operation for a trigger valve, which activates the striking tool, becomes effective only when the contact member, which has the ejection path for a nail and is slidable along the nose portion, is pressed against the material to be fastened. The contact member is constantly biased by a spring so as to protrude from a tip end of the nose portion in a striking direction. When striking a fastener, a tip end of the contact member is pressed against the material to be fastened until the tip end of the nose portion abuts against a fastening portion of the material, whereby the contact member relatively moves in a direction opposite to the pressing direction. According to this movement, it is detected that the tip end of the nose portion abuts against the material to be fastened, whereby the operation of the trigger becomes effective. The striking tool is activated only in this state.

In contrast, the non-stroking type is configured such that the contact member is held at a top dead center side so as not to protrude form the tip end of the nose portion. When the tip end of the nose portion is abutted against the material to be fastened and the trigger is pulled, the striking tool is activated. When the trigger is pulled without abutting against the material, only the contact member protrudes and the trigger operation is made invalid. Thus, the working efficiency is good.

JP-A-2002-283253 discloses a nailer having a pressing means for fixing a contact member near a top dead center.

According to the contact type, because the contact member is biased by the spring so as to protrude from the tip end of the nose portion in the striking direction, the contact member is pressed strongly with a force equal to or larger than the spring load when pressing the contact member against the material to be fastened. The large spring load is effective in recognizing a worker that the operation is not erroneous. Further, a worker is used to such a pressing and striking operation unconsciously.

However, because the contact member is biased by the spring so as to protrude from the tip end of the nose portion in the striking direction, the contact member is pressed strongly with a force equal to or larger than the spring load when pressing the contact member against the material to be fastened. Thus, for example, when striking a pin nail into a groove of a skirting board, the tip end of the nose portion is narrow so as to engage with the groove so that a surface of the material to be fastened may be damaged or impressed due to an impact applied at the time of pressing. Therefore, as a safety work before the striking, the contact member needs to be pressed with a force slightly larger than the spring force. Accordingly, a worker is required to pay fine attention in adjusting the pressing force, so the work is cumbersome.

In contrast, according to the non-stroking type, the working efficiency is good since the pressing operation of the contact member is not necessary. However, because the contact member is held at the top dead center, there is no cushion due to a spring when abutting the tip end of the contact member against the material to be fastened. Therefore, it is unavoidable to cause damage or a recess when striking into a soft material such as a dressed lumber like the skirting board.

Further, the non-stroking type is configured such that a lower end of a trigger valve stem of the activating trigger valve is engaged with a portion above an intermediate portion between a pivotally supporting portion at one end of a contact lever disposed at the trigger and the other end thereof. Accordingly, a stroke of the contact member is large even if a movement of the trigger is small. However, this feature is also a drawback of this type. More specifically, the contact member has a one-piece structure extending in an up-and-down direction, and when the trigger is pulled for striking a nail, the movement of the trigger is transmitted directly to the contact member. However, because the tip end of the contact member is abutted against the material to be fastened and does not move, there is a case where the trigger valve stem is pushed in even when the trigger is pulled slightly so that the nailer is activated. In this case, because the nailer is activated before the nose portion of the nailer is pressed with a sufficiently strong force against the material to be fastened, the nailer is lifted up due to a reaction force. As a result, the nail may not be struck sufficiently, and further, a driving failure or a buckling may occur due to a moment that is generated to rotate the nailer around the grip. Thus, the striking operation may become unstable.

### DISCLOSURE OF THE INVENTION

One or more embodiments of the invention provide a striking tool in which an activating type can be freely switched in accordance with a kind of work or a work place.

Further, one or more embodiments of the invention provides a striking tool which can, in the case of employing the non-stroking type, provide a margin in the pulling operation of a trigger thereby to stabilize a driving operation and improve operability and workability.

According to one or more embodiments of the invention, the striking tool includes a nose portion which is provided at a lower portion of a main body of the tool to strike a fastener, a contact member which is movable along an ejection path of the nose portion in an up-and-down direction, upper and lower springs which are provided near the nose portion and holds the contact member, and a switching device which switches a position of the contact member between a first position at which a lower end of the contact member is held against the upper spring at an upper position which is substantially the same as a position of a tip end of the nose portion, a second position at which the lower end of the contact member is held against the lower spring at a lower position protruding downward from the tip end of the nose portion, and a third position at which a movement of the contact member is not restricted.

At the first position, the contact member is held at the upper position. Therefore, when striking, it is merely required to contact the tip end of the contact member to a material to be fastened and to pull the trigger. Accordingly, it can be operated by a non-stroking type operation in which the pressing operation of the contact member is not necessary. Thus, when striking while abutting and sliding the tip end of the nose portion against and along the surface of the material to be fastened, or when striking at a high position so that a worker is required to take a posture difficult to perform the pressing operation, the working efficiency is good because the spring load is not necessary for the pressing.

At the second position, the contact member is held at the lower position. Therefore, when striking, the actual driving is made possible only when the trigger is pulled after pressing the contact member against the material to be fastened. Because the contact member is further moved downward against the lower spring, the tool is not activated even when the trigger is pulled. Thus, a contact type operation can be carried out and the safety is ensured.

Further, when striking a nail with a posture which causes a load applied to be more than necessary from the above, e.g. when striking a nail into a coupling portion of floor panels, according to the contact type operation, the nailer is applied with a load more than necessary with the enhanced the cushioning property and the increased pressing load. Thus, a shift from a target position due to a reaction force can be efficiently prevented so that the striking operation can be performed accurately.

At the third position, the contact member is held between the upper and lower two springs, and this configuration provides the cushioning property. Further, because the stroke of the contact member is short in the actual striking, the control of a force upon pressing is easy. Thus, damage or a recess is hardly formed even when striking a fastener into a soft material, and the operability is good.

As described above, because the actuating type using the contact member can be switched and selected freely, the optimum driving operation can be performed in accordance with the kind and the location of a work, and also in accordance with the degree of the importance of a work, such as a finishing, a quick work or a reliable striking, depending on the time or the location. Thus, it is excellent in convenience.

According to one or more embodiments of the invention, the upper spring and the lower spring may be disposed on a common shaft member which moves up and down together with the contact member, and the switching device may include a switching groove formed on a cover disposed on an outer side of the shaft member so as to correspond to the first, second and third positions, and a switching lever which moves up and down together with the shaft member and is engagable with the switching groove.

Therefore, the position of the contact member can be easily and surely switched by moving the shaft member up and down by the switching lever while engaging the switching member with the switching groove.

Further, according to one or more embodiments of the invention, the contact member may be divided into an upper contact member and a lower contact member, that are biased upward. One end of the contact lever may be pivotally supported by the trigger while the other end of the contact lever being engaged with the upper end of the upper contact member, and the middle portion of the lever being engaged with the valve stem. A clearance may be formed between a lower end of the upper contact member and an upper end of the lower contact member when the lower end of the contact member is at the position substantially the same as the position of the tip end of the nose portion. When the trigger is pulled up, the contact lever rotates around a portion engaging with a tip end of the valve stem and moves the upper contact member downward by a distance corresponding to the clearance to engage the upper contact member with the upper end of the lower contact member. When the contact member is downwardly movable, the contact lever rotates around the portion engaging with the tip end of the valve stem serving as a fulcrum. When the contact member can not move downward, the contact lever rotates around the portion engaging with the upper end of the upper contact member serving as a fulcrum and push in the valve stem upward.

According to this configuration, the spring load for the upper contact member can be made smaller than that of the lower contact member. Thus, the pressing load of the upper contact member at the time of pulling the trigger is small while the pressing load when integrated with the lower contact member is large. Accordingly, when pulling the trigger, the pulling load is small at the beginning and then becomes large, and a nail is struck out when the pulling load is large. Therefore, the striking timing of a nail can be well recognized sensuously. That is, since the clearance is provided between the upper contact member and the lower contact member, there is a margin in the pulling operation of the trigger, whereby the striking operation becomes stable. Further, the operability and the workability can be improved.

Further, because the spring for the upper contact member may be sufficient with a low load, a spring of a compact size can be used, so that the spring can be disposed easily.

Other features and effects will be apparent from the description of the embodiment and attached claims.

### BRIEF DESCRIPTION OF THE DRAWINGS

FIG. 1 is a perspective view showing a nailer according to an exemplary embodiment of the invention partially in a sectional view.

FIG. 2 is a side view of the nailer.

FIG. 3 is an explanatory view showing a shaft member in a section taken along the line X-X in FIG. 2.

FIG. 4 is an explanatory view showing main portions when held at a first position.

FIG. 5 is an explanatory view showing a nail driving mode at the first position.

FIG. 6 is an explanatory view showing an activated state when a trigger is pulled without pressing at the first position.

FIG. 7 is an explanatory view showing the main portions when held at a second position.

FIG. 8 is an explanatory view showing a nail driving mode at the second position.

FIG. 9 is an explanatory view showing the main portions in a state in which a clearance is provided between upper and lower contact members at the first position.

FIG. 10 is an explanatory view showing an activated state when the trigger is pulled without a material to be fastened.

FIG. 11 is an explanatory view showing an activated state when the trigger when with the material to be fastened.

### EXPLANATION OF REFERENCE NUMERALS

1 nailer
4 nose portion
12 trigger valve
10 valve stem
11 contact member
23 upper spring
24 lower spring
30 switching groove
31 switching lever

### BEST MODE FOR CARRYING OUT THE INVENTION

Hereinafter, exemplary embodiments of the invention will be described with reference to drawings.

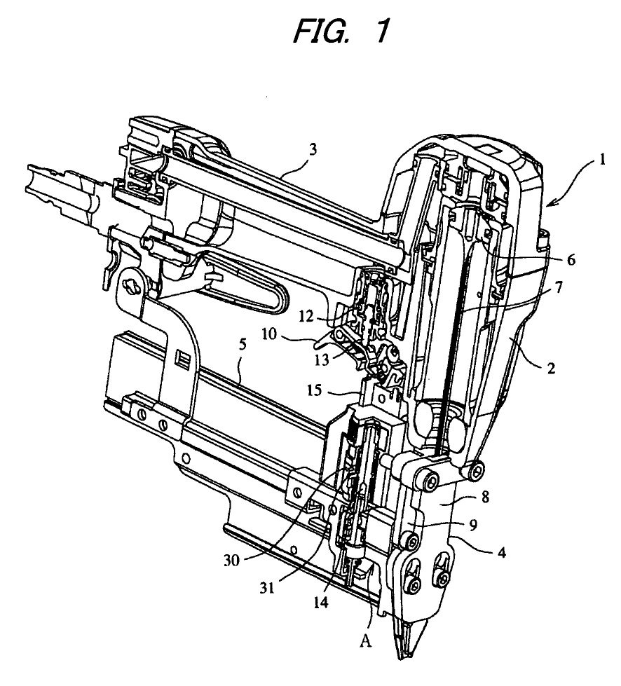

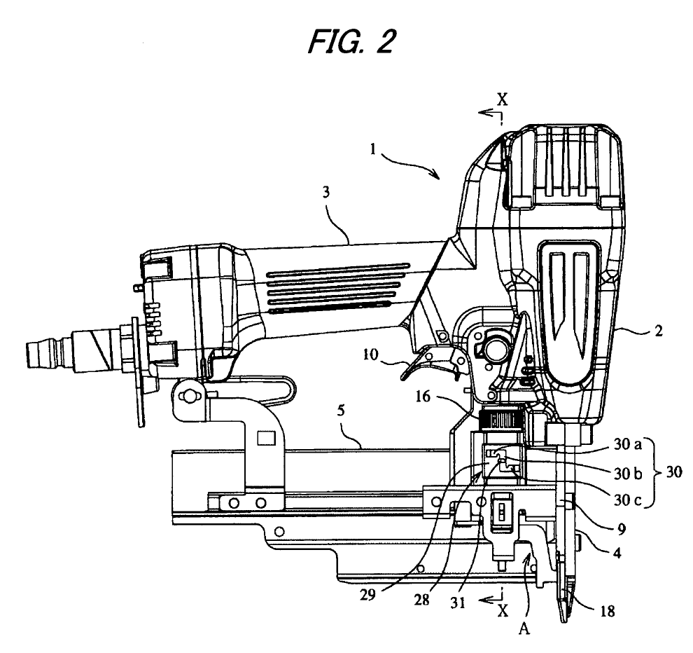

In FIGS. 1 and 2, a reference numeral 1 indicates a nailer (a striking tool). The nailer 1 includes a tool main body 2 having a striking mechanism, a grip 3 disposed on a rear side of the tool main body 2, a nose portion 4 provided at a lower end of the tool main body 2, and a rectangular magazine 5 from which coupled nails (pin nails) are supplied to the nose portion 4. A front nail supplied from the magazine 5 to an ejection path of the nose portion 4 is struck out by a driver 7 which is integrally coupled to a striking piston 6 of the striking mechanism. The ejection path is formed between a driver guide 8 constituting a front wall of the nose portion 4 and a wear plate 9 constituting a rear wall.

When striking a nail, a start-up trigger valve 12 is activated by pulling a trigger 10, and compressed air supplied from an air compressor is sent to the striking mechanism to strike the nail by the air pressure. The pulling operation of the trigger 10 is arranged such that a trigger valve 12 can be activated via a contact arm mechanism A serving as a contract mechanism which will be described below.

The trigger valve 12 is the same as ones that are conventionally known, and is operated such that, a valve stem 13 is pushed downward when the compressed air is supplied from the air compressor, and such that the valve stem 13 is pushed upward by the trigger 10 for activation

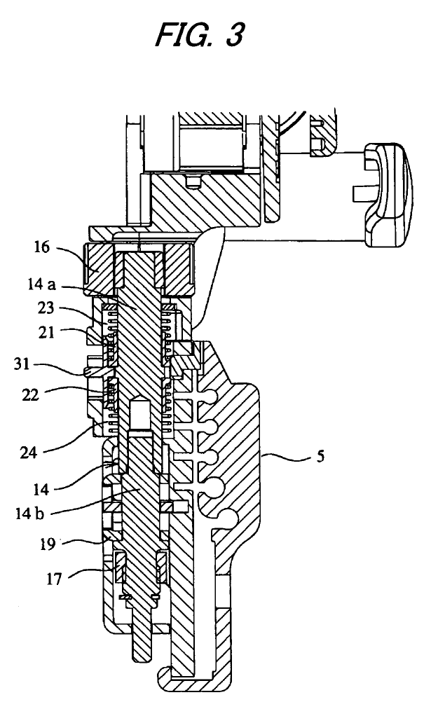

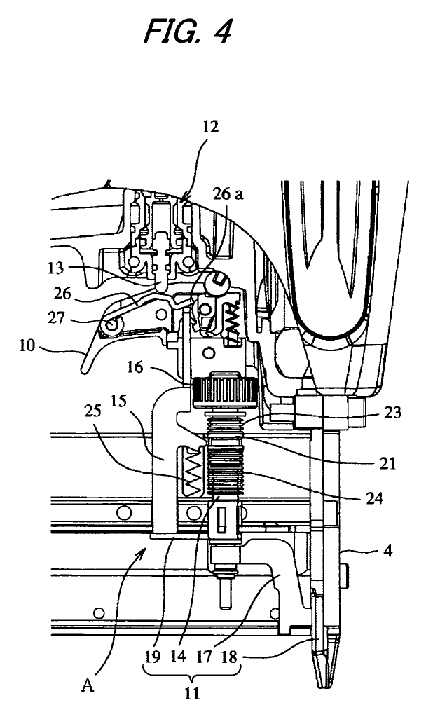

As shown in FIG. 4, the contact arm mechanism A includes a lower contact member 11, which is provided integrally with a shaft member 14 moving in parallel to a shaft center of the nose portion 4, and an upper contact member 15 disposed above the lower contact member 11. As shown in FIG. 3, the shaft member 14 includes an upper shaft member 14a and a lower shaft member 14b which are screwed together. The lower shaft member 14b is provided so as not to rotate with respect to the upper shaft member 14a. An adjust dial 16 is engaged with an upper portion of the upper shaft member 14a. The up-and-down position of a coupling arm 17 can be adjusted by rotating the adjust dial 16.

As shown in FIG. 4, the lower contact member 11 is includes the shaft member 14, a contact portion 18 disposed so as to be directed downward via the coupling arm 17 provided in the forward direction from a lower portion of the shaft member 14, and an operation arm 19 bent at right angle from the lower portion of the shaft member 14. A tip end portion of the wear plate 9 is formed to be thin, and the contact portion 18 is disposed so as to be slidable along a rear surface of thereof.

As shown in FIG. 3, in the magazine 5 is formed with spring receivers 21, 22 at positions corresponding to the upper and lower portions of the shaft member 14. An upper spring 23 and a lower spring 24 are arranged between the upper spring receiver 21 and the operation arm 19 and between the lower spring receiver 22 and the operation arm 19 respectively. Thus, the lower contact member 11 is held between the upper spring 23 and the lower spring 24, and is movable in an upward direction against the upper spring 23 and in a downward direction against the lower spring 24. The stroke of the lower contact member 11 from the stop position to a lower moving end is set to be almost half of the conventional stroke.

As shown in FIG. 4, the upper contact member 15 is disposed so as to be movable in the up-and-down direction, and biased by a spring 25 so as to be placed at its upper position. In a normal state, the upper contact member 15 is engaged with an upper portion of the operation arm 19.

The trigger 10 is disposed at an upper portion of the upper contact member 15. A contact lever 26 is disposed inside the trigger 10 so as to be rotatable around a supporting axis 27. A tip end 26a of the contact lever 26 is provided so as to be able to engage with the upper end 15a of the upper contact member 15.

The center portion of the contact lever 26 is placed below the valve stem 13 of the trigger valve 12. When the tip end side of the contact lever 26 is pushed up to pull the trigger 10 upward while the upper contact member 15 is moved upward, the lower contact member 11 pushes in the valve stem 13 to activate the trigger valve 12.

Next, the contact arm mechanism A is provided with a switching device 28 which can switch between a first position in which the lower contact member 11 is held at the upper position against the upper spring 23, a second position in which the lower contact member 11 is held at the lower position against the lower spring 24, and a third position in which the lower contact member 11 is held at an intermediate position.

As shown in FIG. 2, the switching device 28 includes a switching groove 30 formed on a cover 29, which is disposed on an outer side of the shaft member 14, so as to correspond to the first, second and third positions, and a switching lever 31 which is movable in the up-and-down direction together with the shaft member 14 and is engagable with the switching groove 30.

More specifically, the cover 29 is disposed on the outer side of the shaft member 14 which moves in the up-and-down direction together with the lower contact member 11. On the cover 29, the switching groove 30 is continuously formed at positions corresponding to the aforesaid position, the second position and the third position respectively. The switching groove 30 includes an upper stage groove 30a, a vertical groove 30b and a lower stage groove 30c so as to be formed in a Z-shape. The upper stage groove 30a corresponds to the position in which the lower contact member 11 is held at the upper position against the upper spring 23, the lower stage groove 30c corresponds to the second position in which the lower contact member 11 is held at the lower position against the lower spring 24, and the vertical groove 30b corresponds to the third position in which the lower contact member 11 is held at the intermediate position. These grooves are formed in an opened manner.

The lever 39 is disposed between the spring receivers 21, 22 of the upper shaft member 14a of the shaft member 14 so as to be vertically movable and rotatable. The upper shaft member 14a is rotatable, and moves together with the lower contact member 11 in the up-and-down direction. The switching lever 31 penetrates through the switching groove 30 and can be operated from the outer side, and can be moved continuously to be selectively engaged with one of the upper stage groove 30a, vertical groove 30b and lower stage groove 30c.

According to the above configuration, the lower contact member 11 can be easily and surely switched to a selected position among the first, second and third positions by manually moving the switching lever 31 up and down to engage the switching lever 31 with the switching groove 30.

First, as shown in FIG. 4, when the switching lever 31 is engaged with the upper stage groove 30a to hold at the first position, the spring receiver 21 is moves upward. Accordingly, the upper spring 23 is locked in a deformed state, so that the lower end of the contact portion 18 of the lower contact member 11 is held, by the lower spring 24, at the upper position which is almost the same position as the tip end of the nose portion 4.

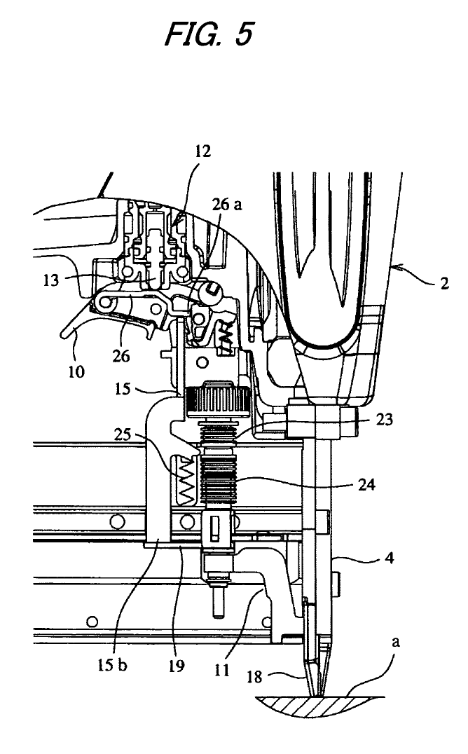

As shown in FIG. 5, when striking a nail in this state, firstly, the contact portion 18 of the lower contact member 11 is abutted against a material a to be fastened. Then, when the trigger 10 is pulled, the contact lever 26 rotates around the engaging portion with respect to the valve stem 13 of the trigger valve 12 while the valve stem 13 serves as a fulcrum, whereby the tip end 26a of the contact lever 26 tries to push the upper contact member 15 downward against the spring 25. However, the lower end 15b of the upper contact member 15 is engaged with the operation arm 19 so that it cannot move downward any further. Thus, the contact lever 26 rotates around a portion engaging with the upper end of the upper contact member 15 serving as a fulcrum. Accordingly, a middle portion of the contact lever 26 pushes the valve stem 13 upward, whereby the trigger valve 12 is activated to start-up the nailer 1 and a nail is struck.

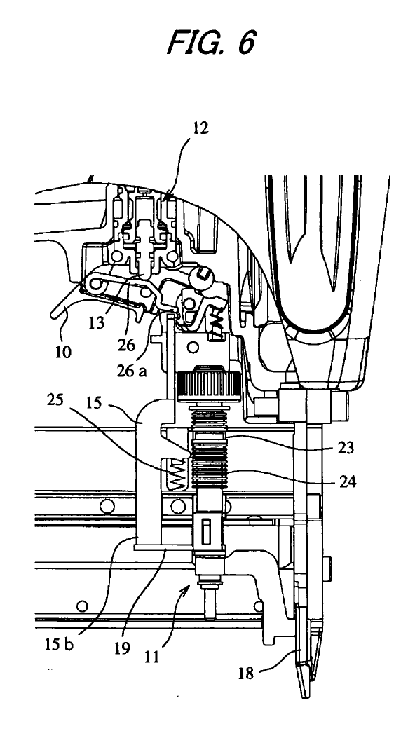

As shown in FIG. 6, when the trigger 10 is pulled without abutting the contact portion 18 against the material a to be fastened, because the valve stem 13 of the trigger valve 12 is pushed downward by the compressed air, the contact lever 26 rotates around the engaging portion engaging with the valve stem 13, whereby the tip end 26a pushes down the upper contact member 15 against the spring 25. Because the lower end of the upper contact member 15 is engaged with the operation arm 19, the shaft member 14 and the contact portion 18 further protrudes downwards against the lower spring 24 together with the operation arm 19. Thus, the nailer 1 is not activated in this case.

As described above, when carrying out a striking operation while the switching lever 31 is engaged with the upper stage groove 30a and is held at the position, the trigger is pulled while contacting the tip end of the lower contact member 11 to the material a to be fastened. Thus, the non-stroking type operation can be carried out in which the pressing operation of the lower contact member 11 is not required.

Thus, when carrying out a striking operation while abutting and sliding the tip end of the nose portion against and along the surface of the material a to be fastened, or when it is difficult to balance due to a pressing work at high places, it is preferable to work with the non-stroking type because the spring load for the pressing operation obstructs workability.

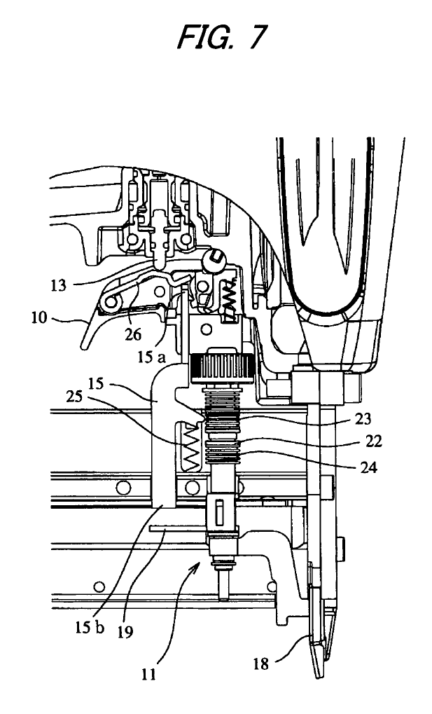

Next, as shown in FIG. 7, when the switching lever 31 is engaged with the lower stage groove 30c to hold at the second position, the spring receiver 22 is moved downward, and the lower spring 24 is locked in a deformed state. The lower end of the contact portion 18 of the lower contact member 11 is held, by the upper spring 23, at the position protruding downward from the tip end of the nose portion 4. In this case, the operation arm 19 and the upper contact member 15 are separated from each other.

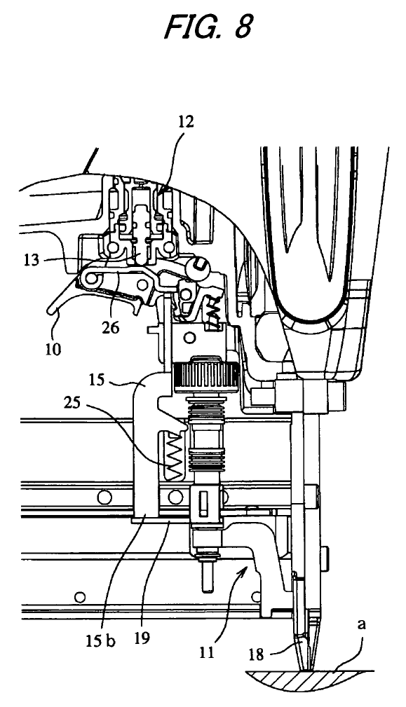

As shown in FIG. 8, when striking in this state, the tip end of the lower contact member 11 is pressed against the material a to be fastened. Thus, the operation arm 19 engages with the lower end of the upper contact member 15. When the trigger 10 is pulled thereafter, the contact lever 26 rotates around the engaging portion with respect to the valve stem 13 of the trigger valve 12 while the valve stem 13 serves as the fulcrum, whereby the contact lever 26 tries to push down the upper contact member 15 against the spring 25. However, the lower end 15c of the upper contact member 15 is engaged with the operation arm 19 so that it cannot move downward any further. Thus, the contact lever 26 rotates around the portion engaging with the upper end of the upper contact member 15 serving as the fulcrum. Accordingly, the middle portion of the contact lever 26 pushes the valve stem 13 upward, whereby the trigger valve 12 is activated to start up the nailer and a nail is struck.

As shown in FIG. 7, when the trigger 10 is pulled without abutting the contact portion 18 against the material a to be fastened, because the valve stem 13 of the trigger valve 12 is pushed downward by the compressed air, the contact lever 26 rotates around the engaging portion engaging with the valve stem 13, whereby the tip end 26a abuts against the upper end 15a of the upper contact member 15 and pushes down the upper end against the spring 25. However, the lower end 15b of the upper contact member 15 merely engages with the operation arm 19, the upper contact member 15 is placed in an air shot state. Thus, because the valve stem 13 can not be pushed in, the nailer 1 is not activated.

As described above, the actual striking operation is made possible only when the tip end of the lower contact member 11 is pressed against the material a to be fastened. Further, because the lower spring 24 is fixed in the deformed state so that the operating range of the upper spring 23 becomes larger by a length corresponding to the deformed amount, the stroke of the lower contact member 11 becomes larger. Thus, in this case, since the operation is carried out with the complete contact type, the safety can be ensured.

Further, when striking a nail into a coupling portion of floor boards, the tip end is abutted against the material a to be fastened with a posture of bending a waist. Because a load may be applied more than necessary from above with such a posture, according to the non-stroking type operation or a low-load contact type which will be described later, the material a to be fastened may be impressed or a surface of the material a may be damaged by missing a target point due to the reaction force at the time of striking. However, according to the contact type striking operation, because the nailer is applied with a load more than necessary with an increased pressing load due to the enhanced cushioning property, a misalignment from the target position due to the reaction force can be efficiently prevented, whereby an accurate striking operation can be performed.

Further, when the switching lever 31 is engaged with the vertical groove 30b to hold at the third position, the lower contact member 11 becomes movable an the up-and-down direction. In this state, as shown in FIG. 3, the spring action of both the upper spring 23 and the lower spring 24 affects on the lower contact member 11. Thus, as shown in FIG. 2, a protruding amount of the contact portion 18, which is at the tip end of the lower contact member 11, from the nose portion 4 is smaller than that in the case where it is held at the second position (in the case shown in FIG. 7). Further, the pressing load of the lower contact member 11 is smaller than that in the case where it is held at the second position.

When striking a nail, like the case of FIG. 5 where the switching lever 31 is held at the second position, the trigger 10 is pulled after pressing the contact portion 18 of the lower contact member 11 against the material a to be fastened. The moving amount of the lower contact member 11 due to the pressing and the pressing load are smaller than those in the case where it is held at the second position.

When the trigger 10 is pulled without abutting the contact portion 18 against the material a to be fastened, the nailer is not activated like in the case where it is held at the second position.

As described above, according to the operating type at the third position, the protruding amount of the lower contact member 11 from the tip end of the nose portion is smaller than that in the case where it is held at the position. Thus, this type may be called as a short stroke type which is a combination of the contact type and the non-stroking type.

The configuration of holding the lower contact member 11 between the upper and lower springs 23, 24 provides the cushioning property. In addition, the stroke of the lower contact member 11 is short when actually striking a nail, and it is not necessary to press with a strong force. Thus, the striking operation can be easy controlled. Therefore, even when striking a nail into a soft material a to be fastened, damage or a recess is hardly formed. In addition, good operability is provided.

As described above, since either the non-stroking type, the contact type and the short stroke type can be freely selected by operating the switching lever 31, the optimum striking operation can be performed in accordance with what is important in the work, e.g. a finishing, a quick work or a reliable striking, depending on the kind, the location and the time of a work. Thus, it is excellent in convenience.

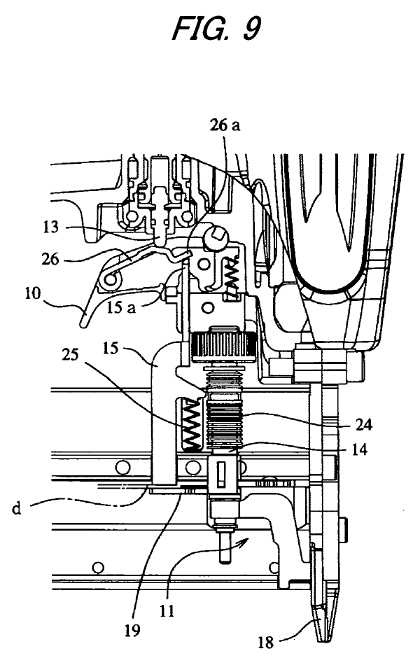

Next, in a case where the non-stroking type is selected, it is not limited to an example in which the upper contact member 15 and the lower contact member 11 are moved together. For example, as shown in FIG. 9, a clearance d may be formed between the lower end of the upper contact member 15 and the upper end of the lower contact member 11. Thereby, when pulling and rotating the trigger 10, the contact lever 26 rotates around the portion engaging with the tip end of the valve stem 13, and the upper contact member 15 is moved downward by the clearance d and engages with the upper end of the lower contact member 11.

Because a shock applied to the upper contact member 15 is smaller than that applied to the lower contact member 11, the contact member may be a light-weighted member. Thus, the spring load of the spring 25 for biasing the upper contact member 15 upward is set to be smaller than that of the lower spring 24 for biasing the lower contact member 11 upward.

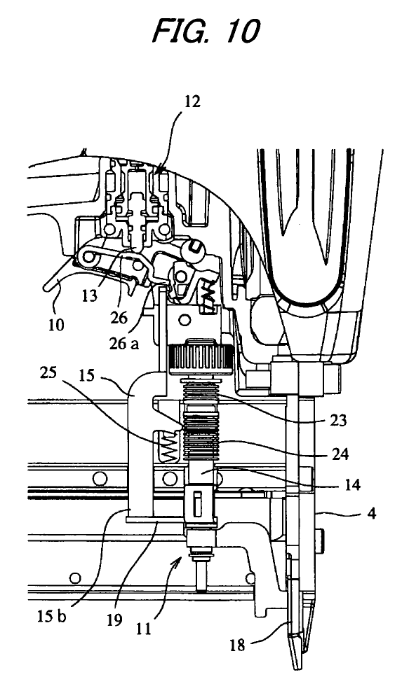

When the lower contact member 11 is movable in a downward direction, the contact lever 26 rotates around the portion engaging with the valve stem 13 serving as the fulcrum, whereby the tip end 26a of the contact lever 26 pushes down the upper contact member 15 against the spring 25 as shown in FIG. 10. Because the lower end of the upper contact member 15 is engaged with the operation arm 19, both the shaft member 14 and the contact portion 18 further protrude downward together with the operation arm 19 against the lower spring 24. Thus, the nailer 1 is not activated in this case.

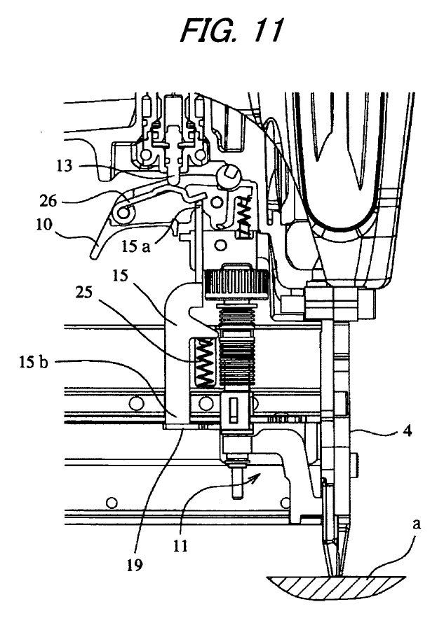

In contrast, win a case where the tip end of the lower contact member 11 is engaged with the material a to be fastened so that it cannot move downward, as shown in FIG. 11, when the trigger 10 is pulled, the contact lever 26 rotates around the portion engaging with the upper end of the upper contact member 15 serving as the fulcrum. Thus, the middle portion of the contact lever 26 pushes the valve stem 13 upward, whereby the trigger valve 12 is activated to start up the nailer 1 and a nail is struck.

As described above, the spring load of the upper contact member 15 can be made smaller than that of the lower contact member 11. Thus, the pressing load of the upper contact member 15 at the time of pulling the trigger 10 is small, and the pressing load when moving together with the lower contact member 11 is large. Accordingly, while pulling the trigger 10 to strike a nail, the pulling load is small at the beginning and then becomes large, and when the pulling load becomes large, the valve stem 13 is pushed to start up so that a nail is struck out. Therefore, a timing at which a nail is to be stuck can be well recognized sensuously. Namely, a margin corresponding to the clearance d is generated in the pulling operation of the trigger 10 by providing the clearance d between the upper contact member 15 and the lower contact member 11, so that, unlike the conventional art, the nailer is not activated only by slightly pulling the trigger. Further, since the pulling load of the trigger 10 is small at the beginning and then becomes large, the operability is good, and the striking operation is stable. Thus, workability can also be improved.

The clearance d between the upper contact member and the lower contact member 11 is preferably in a range of 1 to 2 mm. This is because, when the clearance is 2 mm or more, the pulling amount of the trigger 10 becomes too large so that the operability is not good and a worker is likely to fatigue. Further, the operation efficiency is degraded and the size of the nailer becomes large. In contrast, when the clearance is 1 mm or less, like the conventional art, the nailer is activated even when the trigger 10 is slightly pulled.

Further, because the spring 25 of the upper contact member 15 may have a low load, a spring having a compact size can be used. Thus, the spring can be easily disposed.

Further, the conventional one-piece structured contact arm is a one-piece member that is bent at an intermediate portion thereof. Thus, when a point of the arm is pushed, a moment acts due to differences in sliding resistance at respective portions thereof so that it is difficult to slide smoothly. Therefore, a complex measure for sliding is required in order to smoothly move the entire arm in the same direction. In contrast, because the contact member described above is divided in the vertical direction, the sliding resistance is small. Thus, a measure for sliding is easy.

Although not shown, an air shot preventing mechanism may be employed and configured such that the operation arm 19 is rotatable in a horizontal direction and the tip end thereof is provided with a protruding portion which protrudes inside a nail supply path of the magazine, and such that the operation arm 19 is moved to a position engaging with the upper contact member 15 when a nail is inside the magazine, and the protruding portion moves into the nail supply path and simultaneously the operation arm 19 rotates to move to a position not engaging with the upper contact member 15 thereby invalidating the operation of the trigger 10 when the nail is not inside the magazine. In this case, the rotation of the operation arm 19 does not interfere with the upper contact member 15 because of the clearance d. Thus, the activation can be surely performed.

The contact portion 18 at the tip end of the lower contact member 11 may be a part of the nose portion or may be provided separately from the nose portion.

The lower contact member 11 may be any member so long as it is movable in parallel to the shaft center of the nose portion 4, i.e., along the ejection path. Thus, shapes and coupling configuration of the lower shaft member 14b, the coupling arm 17 and the operation arm 19 are not limited so long as they interlockingly move in the up-and-down direction.

The switching device is not necessarily configured by the switching groove of the Z-shape and the switching lever. For example, the switching groove may be have an I-shape and the switching lever may be formed in a button shape.

Further, the non-stroking type shown in FIGS. 9 to 11 may not have to be switched with the contact type, and may be configured as a single non-stroking type.

The present invention is not limited to a striking operation of a nail, and may also be applied to a striking tool for a fastener such as a driving screw or a staple. Further, the present invention is not limited to a pneumatic toll, and may also be applied to a electrically-driven striking tool.

Although the invention is explained as to the particular embodiment, it would be clear for those skilled in the art that various modifications and changes may be made without departing from the sprit and the scope of the invention.

The present application is based on Japanese Patent Application (Japanese Patent Application. No. 2005-168523) filed on Jun. 8, 2005 and Japanese Patent Application (Japanese Patent Application. No. 2006-113793) filed on Apr. 17, 2006, the contents of which are incorporated herein by reference.

### INDUSTRIAL APPLICABILITY

The present invention can be utilized in a striking tool such as a nailer or a screw driving machine.

1. A striking tool, comprising:
a nose portion which is provided at a lower portion of a main body of the tool to strike a fastener;
a contact member which is movable along an ejection path of the nose portion in an up-and-down direction;
upper and lower springs which are provided near the nose portion and holds the contact member; and
a switching device which switches a position of the contact member between a first position at which a lower end of the contact member is held against the upper spring at an upper position which is substantially the same as a position of a tip end of the nose portion, a second position at which the lower end of the contact member is held against the lower spring at a lower position protruding downward from the tip end of the nose portion, and a third position at which a movement of the contact member is not regulated.

2. The striking tool according to claim 1, wherein the upper spring and the lower spring are disposed on a common shaft member which moves up and down together with the contact member, and
wherein the switching device comprises:
a switching groove formed on a cover disposed on an outer side of the shaft member so as to correspond to the first, second and third positions; and
a switching lever which moves up and down together with the shaft member and is engagable with the switching groove.

3. The striking tool according to claim 1, further comprising:
a trigger valve;
a trigger which activates the trigger valve; and
a contact lever,
wherein the contact member comprises an upper contact member and a lower contact member,
each of the upper and lower contact members is biased upward,
the contact lever comprises one end pivotally supported on the trigger, the other end engaging with an upper end of the upper contact member, and a middle portion engaging with a valve stem of the trigger valve,
a clearance is formed between a lower end of the upper contact member and an upper end of the lower contact member when the lower end of the contact member is at the position substantially the same as the position of the tip end of the nose portion,
when the trigger is pulled up, the contact lever rotates around a portion engaging with a tip end of the valve stem and moves the upper contact member downward by a distance corresponding to the clearance to engage the upper contact member with the upper end of the lower contact member,
when the contact member is downwardly movable, the contact lever rotates around the portion engaging with the tip end of the valve stem serving as a fulcrum, and
when the contact member can not move downward, the contact lever rotates around the portion engaging with the upper end of the upper contact member serving as a fulcrum and push in the valve stem upward.
